(19) United States
(12) Patent Application Publication
(10) Pub. No.: US 2004/0237315 A1
(43) Pub. Date: Dec. 2, 2004

(54) Vegetation trimmer apparatus

(76) Inventor: George E. Alliss, Lumberton, NC (US)

Correspondence Address: John F. Letchford, Klehr, Harrison, Harvey, Branzburg & Ellers, 260 South Broad Street, Philadelphia, PA, 19102, US

(21) Appl. No.: 10/693,160

(22) Filed: Oct. 24, 2003

Related U.S. Application Data
(63) Continuation-in-part of application No. 10/411,708, filed on Apr. 14, 2003.
Application No. 10/411,708 is a continuation-in-part of application No. 10/222,375, filed on Aug. 16, 2002, now Pat. No. 6,581,292.
(60) Provisional application No. 60/312,988, filed on Aug. 17, 2001.

(51) Int. Cl. B26B 7/00

(52) U.S. Cl. 30/276; 30/347

(57) ABSTRACT

A motorized vegetation trimmer apparatus comprising an elongate main handle to which is connected a motor that rotatably drives a trimmer head located at a distal end of the handle. The trimmer head carries one or more radially outwardly projecting cutting members which cut vegetation as the trimmer head rotates. Each cutting member comprises a finite length of flexible strand. The cutting member is releasably gripped by a one-way gripping mechanism including a reciprocating gripping member and a device for biasing the gripping member into gripping contact with the strand.

### CROSS-REFERENCE TO RELATED APPLICATIONS

This application is a continuation-in-part of U.S. patent application Ser. No. 10/411,708 entitled VEGETATION TRIMMER APPARATUS filed Apr. 14, 2003, which is a continuation-in-part of U.S. patent application Ser. No. 10/222,375 entitled VEGETATION TRIMMER APPARATUS filed Aug. 16, 2002, now U.S. Pat. No. 6,581,292, which claims the benefit of U.S. Provisional Patent Application Serial No. 60/312,988 entitled VEGETATION CUTTING HEADS filed Aug. 17, 2001.

### FIELD OF THE INVENTION

The present invention relates in general to vegetation trimmer apparatus and in particular to vegetation trimmer apparatus having flexible cutting members.

### BACKGROUND OF THE INVENTION

Internal combustion engine and electric motor powered vegetation trimmers are commonly used to cut and trim grass, weeds, brush and other vegetation. The typical motorized trimmer comprises an elongate handle which to which is connected an internal combustion or electric motor which rotatably drives a trimmer head located at a distal end of the handle. The trimmer head, in turn, carries one or more radially outwardly projecting cutting members or blades which cut the vegetation as the trimmer head rotates.

In heavy duty internal combustion trimmers, the trimmer head may include one more flexible or rigid cutting means. If rigid, the cutting means assume the form of blades fabricated from plastic and/or metal and often having corrugations about their peripheral cutting edges. The blades are pivotally attached to the trimmer head such they yield when they contact hard objects, thereby prolonging the service lives of the blades. Rigid blades are normally used to cut very dense vegetation and may cause considerable injury to the trimmer operator or other persons should they accidentally be struck by the blades during operation of the trimmer.

In lighter duty electric trimmers, the cutting means may be fabricated as a continuous strand flexible monofilament plastic line wrapped about a spool contained within the trimmer head. In such devices, the plastic line is typically selectively dispensed by the centrifugal force generated by rotation of the trimmer head. A disadvantage common to these sorts of devices is that the line frequently becomes jammed when a user attempts to dispense fresh line from the spool. When this occurs, the user must stop the trimming operation, disassemble the trimmer head, fix the jam and reassemble the trimmer head before resuming trimming. Such repeated disruption can be quite frustrating and time-consuming.

Recently, some vegetation trimmers have come to employ finite lengths of monofilament plastic line or string that can be quickly and easily replaced as they become broken or worn without need to resort to disassembly and reassembly of the trimmer head. Each of these designs uses a one-way gripping means that permits withdrawal of a worn or broken string from a central portion of the trimmer head and insertion of a new replacement string through a peripheral wall of the trimmer head to replace the old string. Once inserted into the trimmer head, the one-way gripping means resists withdrawal of the new string in the direction opposite that to which it was inserted into the trimmer head. More particularly, when a new length of trimmer string is inserted through the peripheral wall of the trimmer head it engages a pivotable cam gripping member. The user then continues insertion of the string until a desired length of the string projects from the periphery of the trimmer head for vegetation cutting purposes. When the user releases the string, the cam is biased by a spring into gripping contact with the string. And, when the user reactivates the device, the rotation of the trimmer head generates centrifugal force that enhances the gripping force of the cam. Examples of such devices are provided in U.S. Pat. Nos. 5,758,424; 5,887,348; 5,896,666 and 6,347,455.

Although generally suitable for their intended purposes, the gripping means disclosed by these patents, which employ torsion or tension springs to bias the pivoted cams, constitute an arrangement that is unduly complex in design and less than desirable in terms of cost and ease of manufacture.

An advantage exists, therefore, for a vegetation trimmer apparatus including a rotatable trimmer head for receiving at least one finite length of replaceable trimmer string that is releasably engageable by one-way gripping means of simple design and construction that is economical to manufacture, long-lasting, and adaptable to a wide variety of trimmer head designs.

Other details, objects and advantages of the present invention will become apparent as the following description of the presently preferred embodiments and presently preferred methods of practicing the invention proceeds.

### SUMMARY OF THE INVENTION

The present invention provides a motorized vegetation trimmer apparatus comprising an elongate main handle to which is connected an internal combustion or electric motor that rotatably drives a trimmer head located at a distal end of the handle. The trimmer head, in turn, carries one or more radially outwardly projecting cutting means which cut the vegetation as the trimmer head rotates. The trimmer apparatus preferably includes a steering handle attached to the main handle to facilitate guidance of the apparatus during operation.

The cutting means comprises at least one finite length of pliant strand or string. The pliant strand is preferably flexible monofilament plastic of a type used in conventional vegetation trimmer apparatus, e.g., nylon or the like. The cutting means is releasably gripped by one-way gripping means including a reciprocating gripping member and means for biasing the gripping member into gripping contact with the string. The gripping means are uncomplicated in design, reliable in operation, comparatively inexpensive and simple to manufacture, and readily adaptable to a wide variety of trimmer head designs.

### BRIEF DESCRIPTION OF THE DRAWINGS

The invention will become more readily apparent from the following description of preferred embodiments thereof shown, by way of example only, in the accompanying drawings wherein:

FIG. 1 is a perspective view of a motorized vegetation trimmer apparatus including a rotatable trimmer head and a plurality of flexible cutting means according to the present invention;

FIG. 2 is partially exploded and elevational cross-section view of a first embodiment of a trimmer head constructed according to the present invention;

FIG. 3 is a top plan view of a first embodiment of a bottom body member of a trimmer head constructed according to the present invention;

FIG. 4 is a top plan view of the trimmer head bottom body member of FIG. 3 depicting a first embodiment of trimmer line gripping means according to the present invention disposed therein;

FIG. 5 is a top plan view of a further embodiment of a bottom body member of a trimmer head constructed according to the present invention;

FIG. 6 is a top plan view of the trimmer head bottom body member of FIG. 5 depicting a further embodiment of trimmer line gripping means according to the present invention disposed therein;

FIG. 7 is a top plan view of a further embodiment of embodiment of a bottom body member of a trimmer head constructed according to the present invention;

FIG. 8 is a top plan view of the trimmer head bottom body member of FIG. 7 depicting a further embodiment of trimmer line gripping means according to the present invention disposed therein;

FIG. 9 is a top plan view of a further embodiment of a bottom body member of a trimmer head and a further embodiment of trimmer line gripping means disposed therein constructed according to the present invention;

FIG. 10 is an enlarged view of the trimmer line passageway and associated trimmer line gripping means receiving chamber of FIG. 9 with the trimmer line and gripping means omitted for clarity of illustration;

FIG. 11 is an enlarged view of the trimmer line gripping means of FIG. 9 in a non-trimmer line gripping disposition;

FIG. 12 is a cross-section view of the trimmer line gripping means of FIG. 9 taken along line A-A of FIG. 11; and

FIG. 13 is an enlarged view of the trimmer line gripping means of FIG. 9 in a trimmer line gripping disposition.

### DETAILED DESCRIPTION OF THE INVENTION

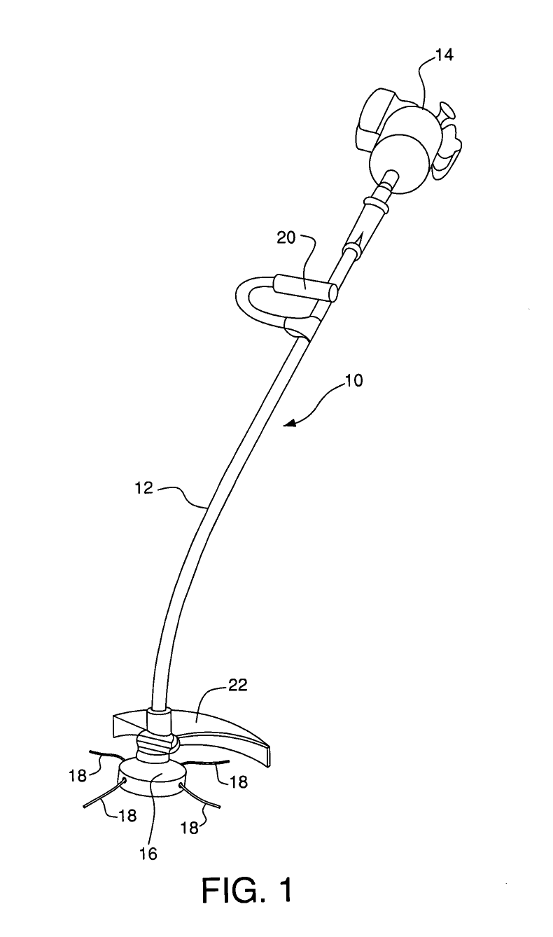

Referring to the drawings, wherein like references indicate like or similar elements throughout the several views, there is shown in FIG. 1 a motorized vegetation trimmer apparatus 10 according to the present invention. Apparatus 10 comprises an elongate main handle 12 which to which is connected an internal combustion or electric motor 14 which rotatably drives a trimmer head 16 located at a distal end of the handle. Trimmer head 16 carries one or more radially outwardly projecting cutting means 18 which cut the vegetation as the trimmer head rotates. Preferably, trimmer apparatus 10 includes a steering handle 20 attached to the main handle 12 to facilitate guidance of the apparatus during operation. A shield 22 is also desirably provided for the operator's safety.

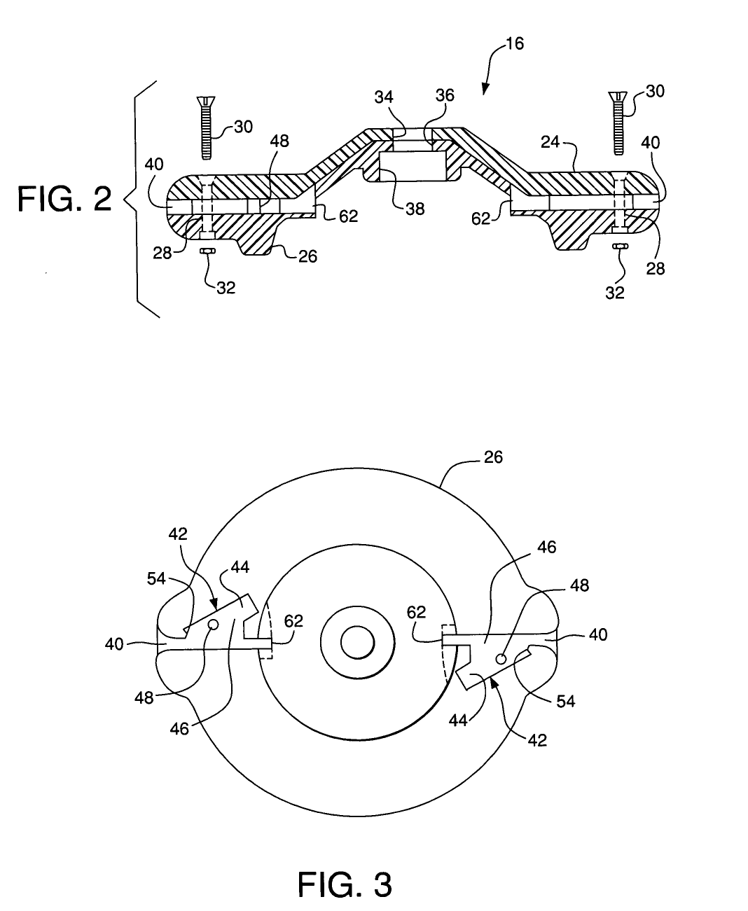

Referring to FIG. 2 there is shown a first presently preferred embodiment of a trimmer head 16 according to the invention that is used for cutting vegetation in conjunction with an internal combustion or electric powered trimmer apparatus such as apparatus 10 shown in FIG. 1. Trimmer head 16 preferably comprises a rigid molded plastic first or “top” body member 24 and a rigid molded plastic second or “bottom” body member 26. Upon installation of the trimmer line gripping means described hereinafter, body members 24,26 (and their counterparts in FIGS. 5-8) may be permanently or releasably fastened to one another. To facilitate maintenance or repair of the trimmer head 16, body members 24,26 may be releasably connected by cooperating snaps, latches or, as illustrated, a plurality of aligned bores 28 provided in each of the body members that receive a corresponding number of conventional bolts/screws 30 and nuts 32. As used herein, the terms “top” and “bottom” refer to the relative positions that body members 24,26 (and their counterparts in FIGS. 5-8) would assume when trimmer head 16 is “in use,” i.e., when attached to the rotating drive shaft of a conventional internal combustion or electric powered trimmer apparatus.

In order to attach trimmer head 16 to the rotating drive shaft of a trimmer apparatus, body members 24,26 (and their counterparts in FIGS. 5-8) are provided with aligned central bores, identified respectively by reference numerals 34 and 36 in FIG. 2, of a diameter sufficient to receive the unillustrated drive shaft. The underside of second body member 26 (and its counterpart in FIGS. 5-8) is preferably molded so as to provide an integral central socket, identified by reference numeral 38 in FIG. 2, for closely receiving an unillustrated conventional hexagonal or other bolt that is adapted to threadedly mate with the drive shaft and releasably attach trimmer head 16 to the drive shaft. The purpose of socket 38 is assure that trimmer head 16 is rotatably driven in unison with the drive shaft. Socket 38 prevents slippage of trimmer head 16 with respect to the drive shaft in the event that the cutting members of trimmer head 16 (described below) encounter solid objects or dense or otherwise difficult to cut grass, weeds or other vegetation.

Trimmer head 16 includes at least one passageway 40 for releasably receiving at least one cutting member 18 in the form of a finite length (approximately 4-12″ in length) of flexible monofilament plastic trimmer line, typically nylon strand. Each cutting member 18 (and its counterpart(s) in FIGS. 5-8) may be any constructed as a flexible yet rugged filament, string or wire. Preferably, each cutting member is a commercially available flexible monofilament plastic trimmer line of any suitable type and cross-sectional configuration, e.g., 0.065, 0.080, 0.095, 0.105, 0.12, 0.13 or 0.15 gauge nylon trimmer line or the like, which is currently used as cutting filaments in conventional vegetation trimmer apparatus.

Although a minimum of one cutting member 18 and passageway 40 may be used in trimmer head 16 (and its counterparts in FIGS. 5-8), according to a presently preferred embodiment, two oppositely directed cutting members 18 are deployed in the trimmer head. Furthermore, it will be understood that trimmer head 16 (and its counterparts in FIGS. 5-8) may include three or more preferably equiangularly spaced passageways for accommodating a corresponding number of cutting members.

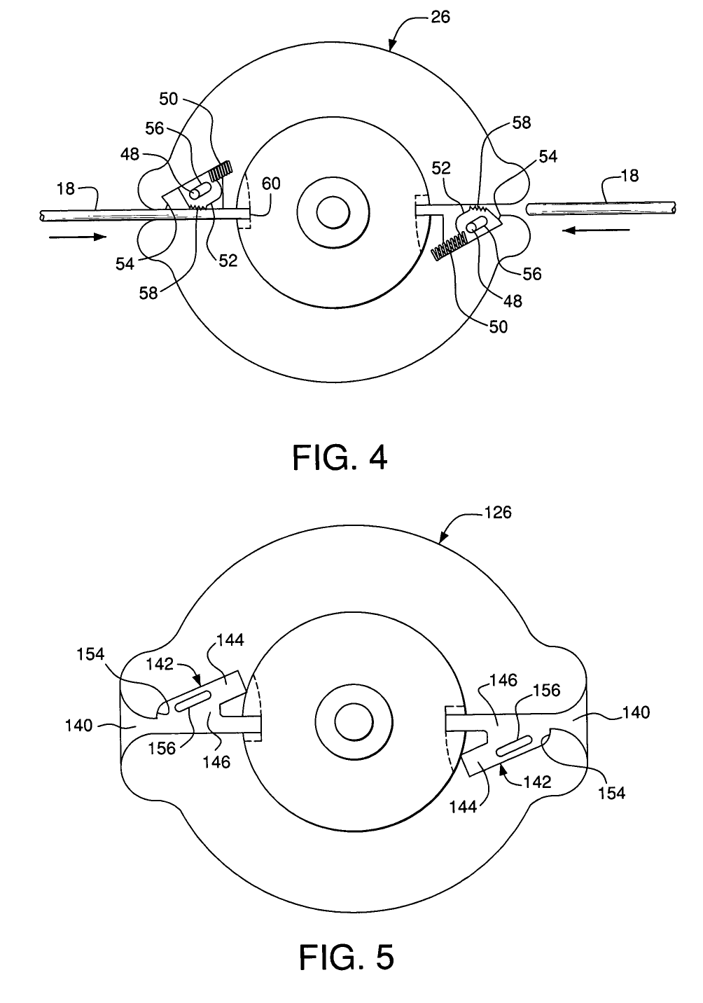

As seen in FIG. 3, for each cutting member 18, body member 26 is constructed so as to provide a chamber 42 for receiving means for releasably gripping cutting members 18. Chamber 42 may be molded directly into body member 26 or it may be formed in an insert that is disposable within body member 26. Each of the chambers 42 is in communication with and disposed at an acute angle with respect to its respective passageway 40. Each chamber preferably has a narrow aft portion 44 and an enlarged fore portion 46. Depending on space considerations associated with a particular trimmer head design, the acute angle of chamber 42 may range from about 10° to about 80° with respect to the passageway 40. As explained in connection with the discussion of FIG. 4 below, an upstanding guide pin 48 (shown also in FIG. 1) is preferably molded into body member 26 in fore portion 46 of chamber 42 or in an insert that is disposable within body member 26.

As illustrated in FIG. 4, according to a first presently preferred embodiment, each of the means for releasably gripping cutting member 18 includes suitable biasing means 50 such as a resilient elastomeric member or, as illustrated, a compression spring, adapted to be received within aft portion 44 of chamber 42 and a reciprocally slidable, generally “D-shaped” rigid cleat member 52 adapted to be received within fore portion 46 of chamber 42. One end of biasing means 50 is seated against a rear wall or other abutment of aft portion 44 of chamber 42 whereas the opposite end of biasing means 50 is seated in operative contact with cleat member 52. FIGS. 3 and 4 reveal that body member 26 is preferably provided with a lip 54 which functions as a stop for cleat member 52 when no cutting member 18 is present in passageway 40. And, biasing means 50 is preferably selected to have a length such that it is at least slightly compressed when seated in the aft portion 44 of chamber 42 between the rear wall or other abutment of aft portion 44 and cleat member 52, even when no cutting member 18 is present in passageway 40.

Additionally, cleat member 52 is provided with an elongated slot 56 for receiving guide pin 48. This cooperating pin and slot arrangement between the trimmer head 16 and cleat member 52 assures that the cleat member is restrained to smooth, linear reciprocating motion at the aforementioned acute angle and prevents disengagement of the cleat member from operative contact with biasing means 50 in the event the cutting member 18 should experience violent impacts arising from contact with solid objects and/or especially dense vegetation. And, as indicated by reference numeral 58, the face of cleat member that is adapted to contact cutting member 18 is preferably provided with at least one protrusion means such as one or more ribs or corrugations, knurling or other textured surfacing for enhancing gripping of the cutting member 18 by cleat member 52.

In order to position a cutting member 18 in trimmer head 16, a cutting member is inserted into an opening in the periphery of body member 12 and passed along passageway 40 formed therein until the cutting member comes into contact with face 58 of cleat member 52. The cutting member 18 is then further inserted by the user such that the free end of the cutting member 18 projects a desired distance from the periphery of the trimmer head 16. As the cutting member 18 passes the cleat member 52 it displaces the cleat member in chamber 40 along the aforementioned acute angle. The user then releases the cutting member 18 and the cleat member 52 settles into gripping contact with cutting member 18 under the influence of biasing means 50. If gripping enhancement means 58 is present at the face of cleat member 52, it is preferable that at least one of the protrusions is more salient than the remainder of the protrusions in order to enhance the biting effect of the cleat member 52 on the cutting member. This biting effect is further enhanced by centrifugal force and the action of contact of the cutting member with vegetation or other objects when trimmer head 16 is rotatably driven by the drive shaft of the internal combustion or electric powered apparatus 10. For instance, the last protrusion of the gripping enhancement means in the direction of insertion of cutting member 18 may be the most salient.

In order to replace a damaged or worn cutting member 18, the user stops the trimmer apparatus 10 and grasps the inner end 60 (FIG. 4) of the cutting member 18 from the underside of body member 12 and withdraws the cutting member 18 through a discharge opening 62 of passageway 40 (FIGS. 2 and 3). A new cutting member 18 then may be inserted in its place as described above.

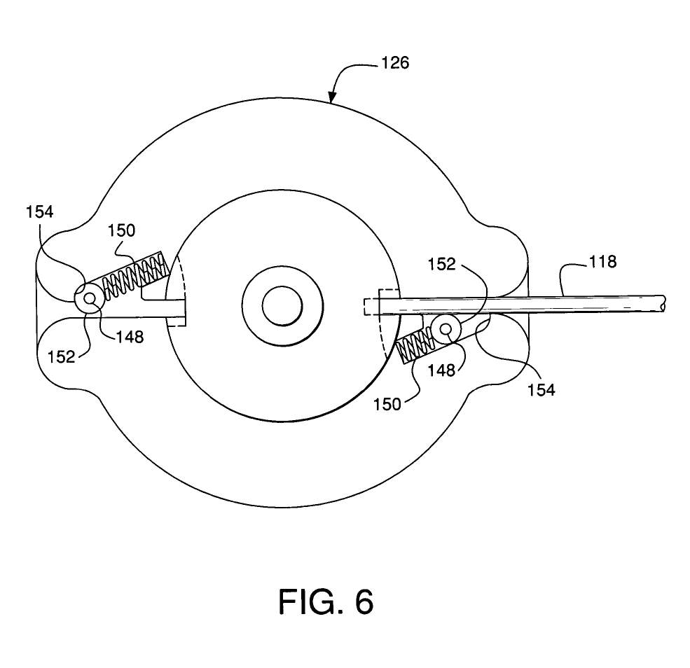

FIGS. 5 and 6 depict a further presently preferred embodiment of the trimmer head and trimmer line gripping means according to the present invention. More particularly, FIG. 5 is a top plan view of a bottom body member 126 of a trimmer head that, like trimmer head 16 of FIG. 2, may be attached to the rotating drive shaft of a conventional internal combustion or electric powered trimmer apparatus such as trimmer apparatus 10 of FIG. 1. Indeed, bottom body member 126 may be fastened to a trimmer head top body member of the same or similar construction as top body member 24 of FIG. 2.

Body member 126 is provided with at least one chamber 142 for receiving means for releasably gripping cutting members 118 (FIG. 6). Each chamber 142 may be molded directly into body member 126 or it may be formed in an insert that is disposable within body member 126. Each of the chambers 142 is in communication with and disposed at an acute angle with respect to its respective passageway 140. Each chamber, in plan view, preferably has a narrow aft portion 144 and an enlarged fore portion 146. Depending on space considerations associated with a particular trimmer head design, the acute angle of chamber 142 may range from about 10° to about 80° with respect to the passageway 140.

As illustrated in FIG. 6, each of the means for releasably gripping cutting member 118 includes a biasing means 150 such as a resilient elastomeric member or, as illustrated, a compression spring, adapted to be received within aft portion 144 of chamber 142 and a reciprocally slidable, generally disk-shaped rigid cleat member 152 adapted to be received within fore portion 146 of chamber 142. One end of biasing means 150 is seated against a rear wall or other abutment of aft portion 144 of chamber 142 whereas the opposite end of biasing means 150 is seated in operative contact with cleat member 152. FIGS. 5 and 6 reveal that body member 126 is preferably provided with a lip 154 which functions as a stop for cleat member 152 when no cutting means 118 is present in passageway 140. And, biasing means 150 is preferably selected to have a length such that it is at least slightly compressed when seated in the aft portion 144 of chamber 142 between the rear wall or other abutment of aft portion 144 and cleat member 152, even when no cutting member 118 is present in passageway 140.

Additionally, cleat member 152 is preferably provided with at least one guide pin 148 projecting from at least one of its upper and lower faces. Each guide pin 148 is adapted for engagement with an elongated slot 156 provided in at least one of bottom body member 126 and the unillustrated top body member. The elongated slots 156 are oriented in a direction parallel to the acute angle of chamber 142. This cooperating pin and slot arrangement between the trimmer head and cleat member 152 assures that the cleat member is restrained to smooth, linear reciprocating motion at the aforementioned acute angle and prevents disengagement of the cleat member from operative contact with biasing means 150 in the event the cutting member 118 should experience violent impacts arising from contact with solid objects and/or especially dense vegetation. Further, the peripheral face of cleat member 152 that is adapted to contact cutting member 118 is preferably provided with means for enhancing gripping of the cutting member 118 by the cleat member.

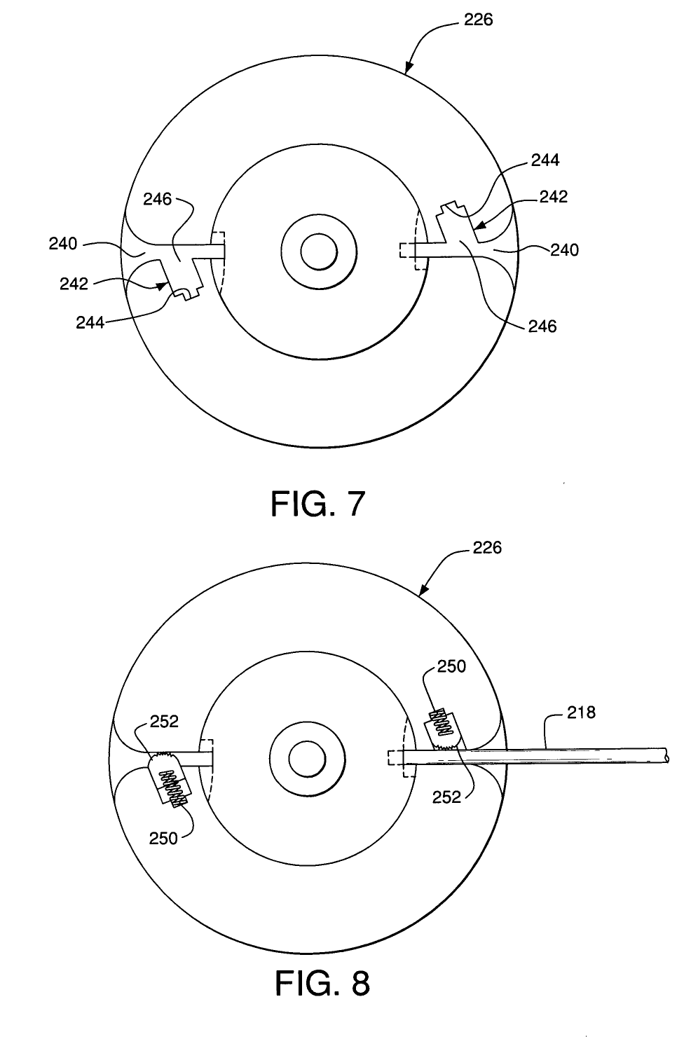

FIGS. 7 and 8 depict a further presently preferred embodiment of the trimmer head and trimmer line gripping means according to the present invention. More particularly, FIG. 7 is a top plan view of a bottom body member 226 of a trimmer head that, like trimmer head 16 of FIG. 2, may be attached to the rotating drive shaft of a conventional internal combustion or electric powered trimmer apparatus such as trimmer apparatus 10 of FIG. 1. Indeed, bottom body member 226 may be fastened to a trimmer head top body member of the same or similar construction as top body member 24 of FIG. 2.

Body member 226 is provided with at least one chamber 242 for receiving means for releasably gripping cutting members 218 (FIG. 8). Each chamber 242 may be molded directly into body member 226 or it may be formed in an insert that is disposable within body member 226. Each of the chambers 242 is in communication with and disposed at an acute angle with respect to its respective passageway 240. Each chamber preferably has a narrow aft portion 244 and an enlarged fore portion 246. Depending on space considerations associated with a particular trimmer head design, the acute angle of chamber 242 may range from about 10° to about 80° with respect to the passageway 240.

As illustrated in FIG. 8, each of the means for releasably gripping cutting member 218 includes a biasing means 250 such as a resilient elastomeric member or, as illustrated, a compression spring, adapted to be received within aft portion 244 of chamber 242 and a reciprocally slidable, generally “U-shaped” rigid cleat member 252 adapted to be received within fore portion 246 of chamber 242. One end of biasing means 250 is seated against a rear wall or other abutment means of aft portion 244 of chamber 242 whereas the opposite end of biasing means 250 is seated about an extension of or, as illustrated, a recessed notch in cleat member 252. Biasing means 250 is preferably selected to have a length such that it is at least slightly compressed when seated in the aft portion 244 of chamber 242 between the rear wall or other abutment means of aft portion 244 and cleat member 252, even when no cutting member 218 is present in passageway 240.

Additionally, cleat member 252 is dimensioned such that it is closely received in the fore portion 246 of chamber 242. This close cooperating arrangement between the trimmer head and cleat member 252 assures that the cleat member is restrained to smooth, linear reciprocating motion at the aforementioned acute angle and prevents disengagement of the cleat member from operative contact with biasing means 250 in the event the cutting member 218 should experience violent impacts arising from contact with solid objects and/or especially dense vegetation. Further, the face of cleat member 252 that is adapted to contact cutting member 218 is preferably provided with means for enhancing gripping of the cutting member 218 by the cleat member.

In each of the embodiments of the trimmer heads thus far described, the aft portions of the cleat member receiving chambers have smaller lateral dimensions, in plan view, than their corresponding fore portions. This is to accommodate biasing means of smaller lateral size, in plan view, than the respective cleat members that they bias. It is contemplated, however, that the lateral dimensions of the fore and aft portions of the cleat member receiving chambers may be substantially equal in plan view. It is also contemplated that lateral dimensions of the aft portions of the cleat member receiving chambers may be greater, in plan view, than the fore portions thereof. Accordingly, the cleat members may be biased by biasing means having lateral dimensions, in plan view, that are equal to or greater than those the cleat members. However, in the event the biasing means is a compression spring having lateral dimensions greater than the cleat member it biases, then an intervening plate, shim or similar member having lateral dimensions at least as large as the spring should be disposed between the spring and the cleat member in order to assure that the spring positively exerts compressive force against the cleat member at all times.

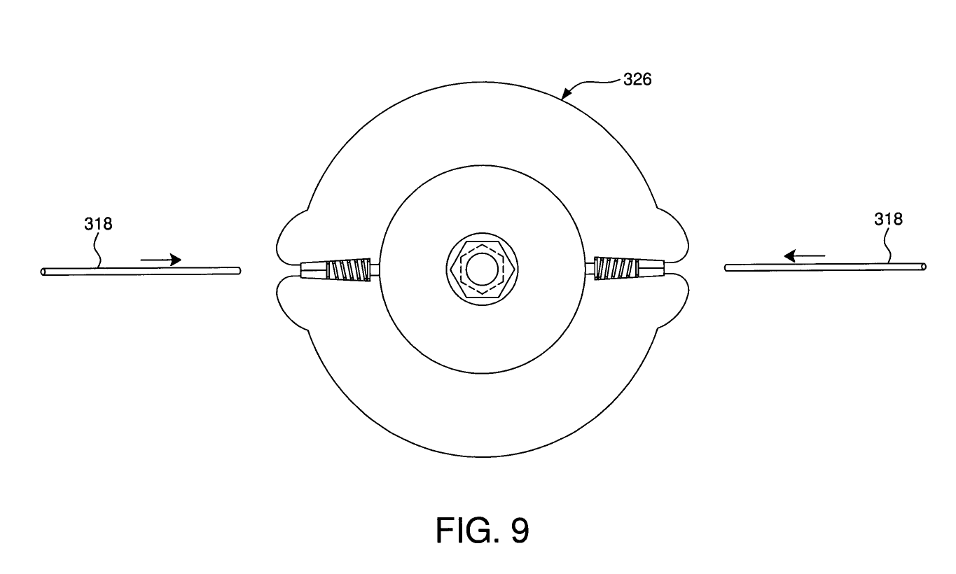

FIG. 9 depicts a further presently preferred embodiment of the trimmer head and trimmer line gripping means according to the present invention. More particularly, FIG. 9 is a top plan view of a bottom body member 326 of a trimmer head that, like trimmer head 16 of FIG. 2, may be attached to the rotating drive shaft of a conventional internal combustion or electric powered trimmer apparatus such as trimmer apparatus 10 of FIG. 1. Indeed, bottom body member 326 may be fastened to a trimmer head top body member of the same or similar construction as top body member 24 of FIG. 2.

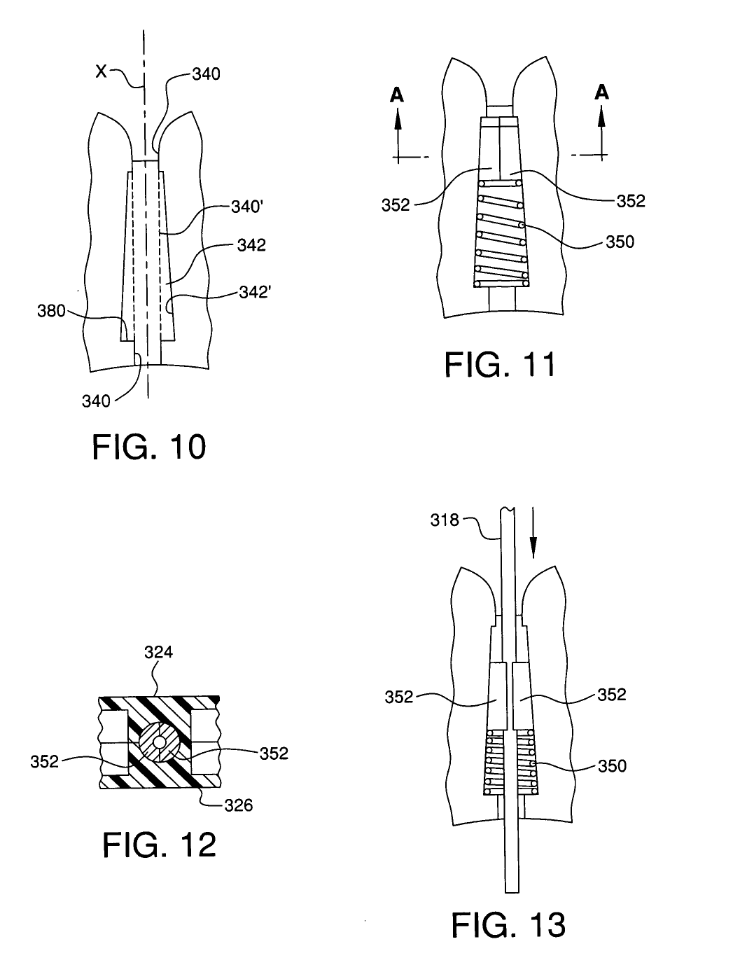

At this juncture, the reader's attention is directed to FIG. 10 which depicts on an enlarged scale one of the trimmer line passageways and associated trimmer line gripping means receiving chambers of FIG. 9 with the trimmer line and gripping means associated therewith omitted for clarity of illustration. As seen in FIG. 10, the trimmer line passageway is identified by reference numeral 340 with the boundaries of its central region being represented by dashed line 340′ and its central axis X being shown in dot-dash line. Situated between the inner and outer ends of passageway 340 is a gripping means receiving chamber 342 in communication with the passageway. Chamber 342 has a tapered wall 342′ disposed at an acute angle with respect to the central axis 340′ of passageway 340 whereby the chamber defines an enclosed three-dimensional, preferably frustoconical, space surrounding the passageway. For ease of installation of the trimmer line gripping means, discussed below, it is preferred that half of the chamber be formed into the top body member 324 and the other half of the chamber be formed into the bottom body member 326 as shown in FIG. 12. Depending on space considerations associated with a particular trimmer head design, the acute angle of chamber wall 342′ may range from about 10° to about 80° with respect to the central axis 340′ of passageway 340.

As shown in FIGS. 11-13, each chamber 342 receives a plurality of semi-annular cooperating gripping members or cleats 352. It is preferable that the gripping members have outer surfaces that taper at an acute angle corresponding substantially to the acute angle of chamber wall 342′. In order to provide optimum contact area of the cleat members 352 with the cutting member 318 (FIGS. 9 and 13) and, therefore, optimum gripping of the cutting member by the cleat members, it is also desirable that the inner surface of each cleat member, i.e., the surface that is adapted to contact the cutting member, extend substantially parallel to the central axis 340′ of passageway 340. Additionally, the cutting member contacting face of each cleat member 352 is preferably provided with at least one protrusion means such as one or more ribs or corrugations, knurling or other textured surfacing for enhancing gripping of the cutting member by cleat member. And, although three or more such gripping members 352 may be disposed in each chamber 342, for ease of construction and reliability of operation, it is preferred that the number of gripping members be limited to two, as illustrated.

Each of the means for releasably gripping cutting member 318 also includes a biasing means 350 disposed in chamber 342. The biasing means may be an elastomeric annular member or, as illustrated, a compression spring (preferably one having a taper substantially corresponding to the acute angle of the chamber wall 342′). Biasing means 350 has one end in operative contact with gripping members 352 and an opposite end in contact with an abutment provided in or otherwise associated with chamber 342, such as a rear chamber wall 380 (FIG. 10).

When cutting member 318 is introduced into the outer opening of passageway 340, it comes into contact with the narrow ends of the cleat members 352 and spring 350 begins to be compressed. As the spring compresses, the cleat members begin to spread apart and travel along the tapered wall 342′ of chamber 342. This continues until the cleat members open a sufficient distance to permit the cutting member to pass between them. When the cutting member is inserted a desired distance into the trimmer head it is released by the installer. As seen in FIG. 13, it is then restrained against removal in the direction of its insertion by the wedging action of the cleat members 352 as generated by the biasing force of compression spring 350. Although not illustrated, the narrow outer ends of the cleat members may be formed with beveled surfaces to facilitate insertion of the cutting member between them and to promote smooth spreading of the cleat members as they travel along the tapered wall 342′ of chamber 342.

In each of the embodiments of the invention disclosed in FIGS. 5-13, worn cutting members are withdrawn from the trimmer head and new cutting members inserted into the trimmer head in the manner described above in connection with FIGS. 3 and 4.

In all of the presently preferred embodiments described herein, the trimmer line gripping means of the present invention is essentially constructed as one or more reciprocating cleat members that is biased via a biasing means into gripping contact with a flexible vegetation cutting member. In contrast, conventional rotating trimmer heads incorporating cam-type trimmer line gripper devices require the provision of pivot pins or similar members to support the pivoting movement of their gripping cams as well multiple anchorages for the means that bias such cams. The inclusion of such components adds not only to the complexity and cost of such devices but also introduces the potential for increased maintenance requirements. It will be appreciated, therefore, that the present invention provides simple, reliable and comparatively inexpensive constructions that may be readily adapted to virtually any rotatable trimmer head design.

Although the invention has been described in detail for the purpose of illustration, it is to be understood that such detail is solely for that purpose and that variations can be made therein by those skilled in the art without departing from the spirit and scope of the invention as defined by the claims.

What is claimed is:

1. A vegetation trimmer head adapted to be rotatably driven by a drive shaft of a motorized vegetation trimmer apparatus, said vegetation trimmer head comprising:
a body including means for enabling releasable attachment of said body to a drive shaft of a motorized vegetation trimmer apparatus;
at least one passageway in said body for receiving a vegetation cutting member of finite length, said at least one passageway having a central axis;
at least one chamber in said body in communication with said at least one passageway, said at least one chamber having a tapered wall disposed at an acute angle with respect to said central axis; and
gripping means disposed in said at least one chamber, said gripping means comprising a plurality of semi-annular cleat members and means for biasing said cleat members into gripping engagement with a vegetation cutting member, wherein said cleat members are reciprocally movable in said chamber along said tapered wall at said acute angle and wherein said biasing means is disposed between said cleat members and an abutment associated with said chamber.

2. The vegetation trimmer head of claim 1 wherein said wherein said cleat members have outer surfaces that taper at an acute angle corresponding substantially to said acute angle.

3. The vegetation trimmer head of claim 2 wherein said cleat members have inner surfaces adapted to contact a vegetation cutting member and that extend substantially parallel to said central axis.

4. A vegetation trimmer apparatus comprising:
an elongate handle;
a motor connected to said handle; and
a rotatable trimmer head connected to said handle and rotatably driven by said motor, said trimmer head comprising:
a body including means for enabling releasable attachment of said body to a drive shaft of a motorized vegetation trimmer apparatus;
at least one passageway in said body for receiving a vegetation cutting member of finite length, said at least one passageway having a central axis;
at least one chamber in said body in communication with said at least one passageway, said at least one chamber defining a tapered wall disposed at an acute angle with respect to said central axis; and
gripping means disposed in said at least one chamber, said gripping means comprising a plurality of semi-annular cleat members and means for biasing said cleat members into gripping engagement with a vegetation cutting member, wherein said cleat members are reciprocally movable in said chamber along said tapered wall at said acute angle and wherein said biasing means is disposed between said cleat members and an abutment associated with said chamber.

5. The vegetation trimmer apparatus of claim 4 wherein said wherein said cleat members have outer surfaces that taper at an acute angle corresponding substantially to said acute angle.

6. The vegetation trimmer apparatus of claim 5 said cleat members have inner surfaces adapted to contact a vegetation cutting member and that extend substantially parallel to said central axis.
